(19) United States
(12) Patent Application Publication
(10) Pub. No.: US 2004/0026883 A1
(43) Pub. Date: Feb. 12, 2004

(54) Generator structure for a tri-wheel scooter

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/215,004

(22) Filed: Aug. 9, 2002

(51) Int. Cl. B62M 1/00

(52) U.S. Cl. 280/87.041

(57) ABSTRACT

A generator structure for a tri-wheel scooter comprises a rear wheel, a wheel axle, a first axle, a second axle, a hub block, and a generator, the wheel is formed with a hole at the center position with the first axle installed on one side of the wheel so as to secure with the wheel axle, the other side of the wheel is formed with the hub block which has a reduced section at one side, and is adapted to connect with the second axle thereat. The generator includes a magnet and an inductive coil, whereas the magnet is secured to the reduced section of the hub block and is wrapped by the inductive coil which is fixed on the frame of the scooter, thus when rotating the magnet with respect to the inductive coil, electricity is generated.

### FIELD OF THE INVENTION

This invention relates to a scooter, more particularly to a scooter equipped with a generator to generate electricity itself and the generator is shock proof.

### BACKGROUND OF THE INVENTION

Tri-wheel scooter has been on the market for a while due to its stability and convenience. However, this design has no power supply unlike the regular two-wheel scooter which has a generator to generate electricity. This generator outputs a limited power, and can only produce limited functions, such as illumination lights, etc. However, the tri-wheel scooter requires more power to generate a lighting system or other devices. The prior generator is not appropriate to the tri-wheel scooter.

In view of this, the inventor has invented the present invention to improve the above-mentioned shortcomings.

### SUMMARY OF THE INVENTION

It is the primary object of the present invention to provide a generator structure for a tri-wheel scooter, which structure is solid and is shock proof.

It is another object of the present invention to provide a generator structure for a tri-wheel scooter, which generates electricity power itself to drive sound and lighting system.

It is a further object of the present invention to provide a generator structure for a tri-wheel scooter, which is more attractive.

### BRIEF DESCRIPTION OF THE DRAWINGS

FIG. 1 is a top view of the present invention;

FIG. 2 is a cross-sectional view of the rear wheel of the present invention; and

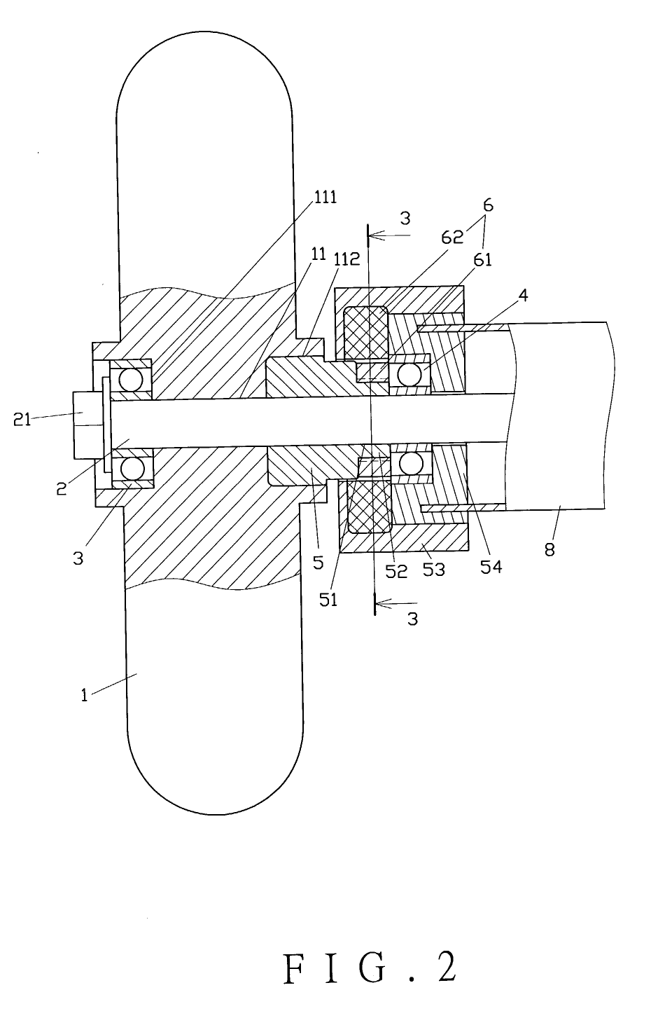

FIG. 3 is a view taken along line 3-3 of FIG. 2.

### DETAILED DESCRIPTION OF THE PREFERRED EMBODIMENT

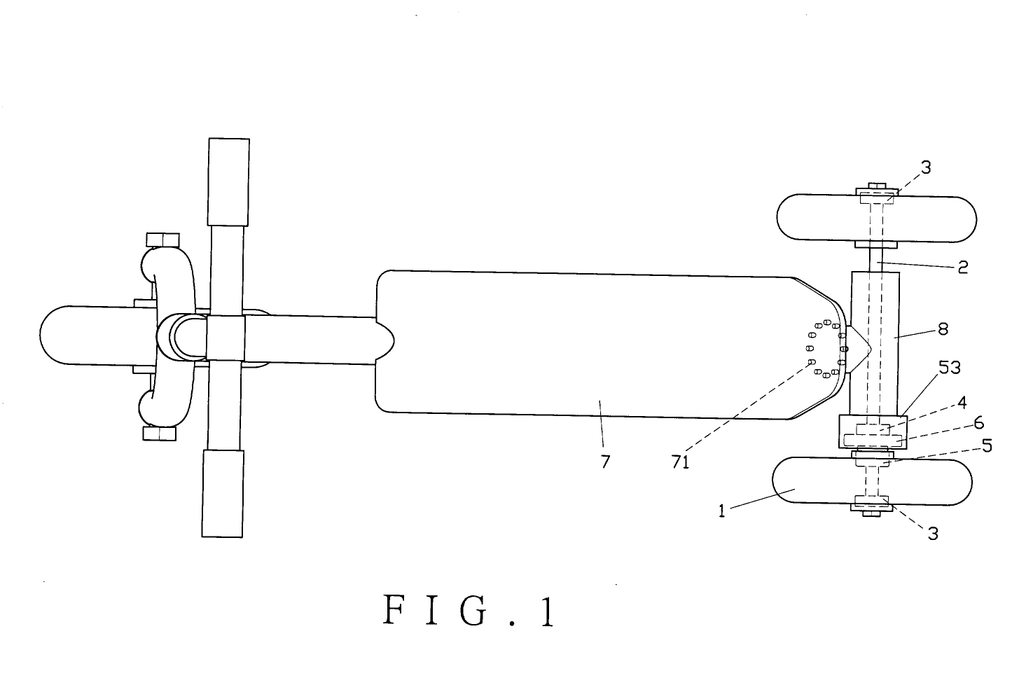

A generator structure for a tri-wheel scooter of the present invention comprises a rear wheel 1, a wheel axle 2, a first axle 3, a second axle 4, a hub block 5, and a generator 6, all of which are installed on a frame 8 of a scooter body 7, as shown in FIG. 1.

The wheel 1 has a hole 11 at the center position with a pair larger holes at two ends, namely as a first larger hole 111 and a second larger hole 112. A portion of the wheel axle 2 is inserted into the hole 11 with the first axle 3 located at the first larger hole 111 and the hub block 5 located at the second larger hole 112.

The wheel axle 2 has one end inserted into the first axle 3 and secured with a nut 21 thereat.

Both of the first axle 3 and the second axle 4 wrap the wheel axle 2.

The hub block 5 has a hole 51 at the center portion to accept the wheel axle 2. One end of the hub block 5 is inserted into the second larger hole 112 and the other end of the hub block 5 has a reduced section 52 which has an outer diameter sized to be inserted into the generator 6, a cover 53 of the hub block 5 is used to enclose the generator 6 therein. The cover 53 comprises a block 54 which is fixed on the frame 8, and the second axle 4 is enclosed therein. The second axle 4 engages with the reduced section 52 and the generator 6.

The generator 6 includes a magnet 61 and an inductive coil 62, and is connected by wires to a battery or light emitting diodes 71 through wires out of the body 7. The inductive coil 62 wraps the magnet 61 and remains a distance from he magnet 61, and is secured with the cover 53 and the block 54. The magnet 61 is secured with the reduced section 52 of the hub block 5 and moved by the block 54, the wheel axle 2 and the rear wheel body 1, respectively, thus when the wheel 1 spins, the magnet 61 and the inductive coil 62 spin in an opposite direction, which generates electricity.

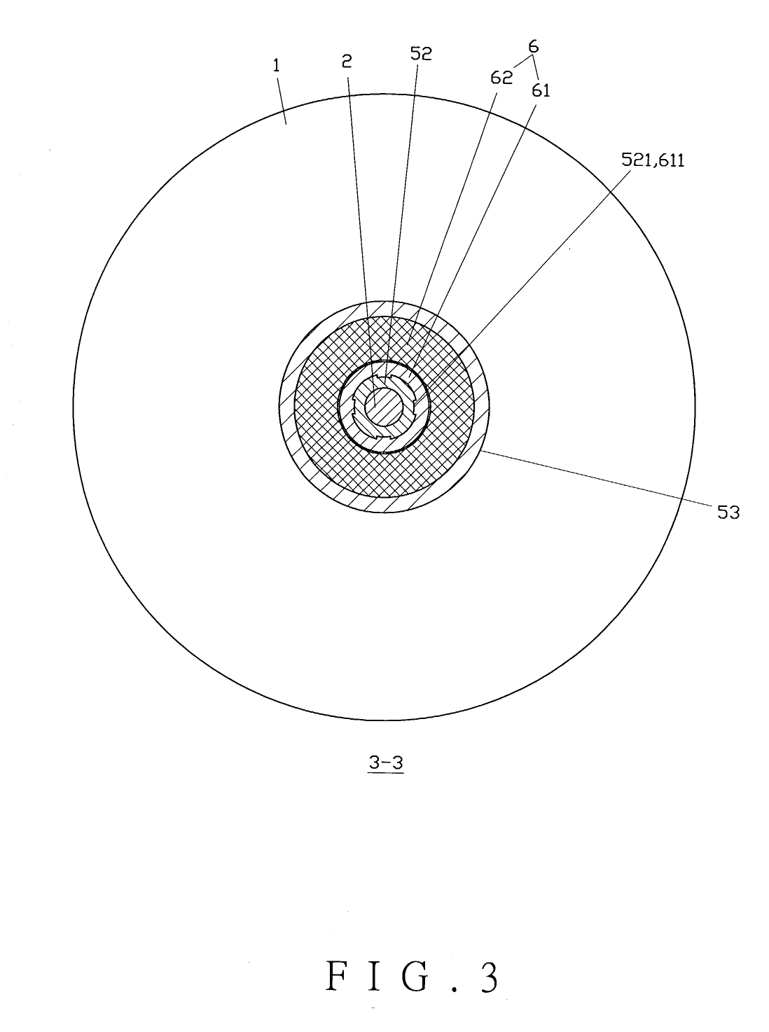

FIG. 3 shows the structure of the generator 6, the magnet 61 comprises feet 611 extending outwardly, and the reduced section 52 of the hub block 5 comprises troughs 521 corresponding to the feet 611 so as to receive the feet 611 therein. This not only connects the magnet 61 to the hub block 5 but also presents the magnet 61 form sliding.

The first axle 3 and the second axle 4 will bear all vibration and shock force from the scooter, therefore, the magnet 61 of the generator 6 will not depart or loosen from the scooter.

I claim:

1. A generator structure for a tri-wheel scooter comprising a rear wheel, a wheel axle, a first axle, a second axle, a hub block, a generator installed on a frame of a scooter body, said wheel having a hole at the center portion to receive said first axle at one side of said hole and said hub block to be fixed at the other side of said hole of said wheel, said hub block having a reduced section at one end, said reduced section being sleeved with said second axle and said wheel axle, said generator comprising a magnet wrapping by an inductive coil with a distance, and said magnet being secured by said reduced section of said hub block, said inductive coil being secured on said frame of said scooter.

2. A generator structure for a tri-wheel scooter, as recited in claim 1, wherein said magnet of said generator comprises feet extending outwardly there from, and said reduced section of said hub block comprises troughs corresponding to said feet of said magnet so that said feet are be inserted into said troughs and secured thereat.

3. A generator structure for a tri-wheel scooter, as recited in claim 1, wherein the respective sides of said hole of said wheel comprises a first larger hole and a second larger hole, said first larger hole is adapted to receive said first axle therein, and said second larger hole is adapted to receive said hub block therein.

4. A generator structure for a tri-wheel scooter, as recited in claim 1, wherein said hub block comprises a cover with a block therein, said block enwraps said second axle therein and is fixed on said frame, and said cover covers said inductive coil of said generator, and wherein said magnet is enwrapped by said inductive coil spaced apart from each other, and said inductive coil spins in an opposing direction with the spin direction of said magnet.
